(19) United States
(12) Patent Application Publication
(10) Pub. No.: US 2021/0192092 A1
(43) Pub. Date: Jun. 24, 2021

(54) DISPLAY APPARATUS

(71) Applicant: HKC Corporation Limited, Shenzhen City, Guangdong (CN)

(72) Inventor: Beizhou HUANG, Shenzhen City, Guangdong (CN)

(21) Appl. No.: 16/068,177

(22) PCT Filed: Dec. 21, 2017
(86) PCT No.: PCT/CN2017/117651

§ 371 Date: Jul. 5, 2018

(30) Foreign Application Priority Data
Oct. 26, 2017 (CN) 201711010956.X

(51) Int. Cl. G06F 21/84; G09G 3/20; G06F 21/81

(52) U.S. Cl. CPC G06F 21/84; G09G 3/2092; G09G 2330/028; G09G 2358/00; G06F 21/81

(57) ABSTRACT

A display apparatus comprises a control module configured to provide a power supply signal and a plurality of control signals and configured to determinate the operation of the control module in a first operation mode or a second operation mode according to a matching signal provided by the system circuit board transmitted to the printed circuit board. And, a security module is electrically coupled to the control module and configured to receive and transmit the power supply signal, wherein the security module includes a plurality of switches comprising a first switch, a second switch, a third switch and a fourth switch. Moreover, a displaying module is electrically coupled to a second terminal of the fourth switch, wherein an open state or a conducted state of each of the plurality of switches is controlled by the control module according to the operation mode of the control module.

### FIELD OF THE INVENTION

The present application relates to a display field, and more particularly to a display apparatus having a security module.

### BACKGROUND OF THE INVENTION

The Thin Film Transistor Liquid Crystal Display (TFT-LCD) is one of the main varieties of the current flat panel display device, and has become an important displaying medium in the modern information technology and the video products. The main driving principle of the thin film transistor display device employs the Red/Green/Blue compressing signals, the control signal, the power control signal and the power provided by the system circuit board connecting to the connector of the printed circuit board (PCB) through the wires. The data and signal provided by the system circuit board is processed by a Timing Controller (TCON) chip on a printed circuit board (PCB) and then transmitting to the source driving chip, may be by the type of Source-Chip on Film (S-COF), and the gate driving chip, may be by the type of Gate-Chip on Film (G-COF), through the connector and the printed circuit board and finally connecting with the display panel. Thus, the thin film transistor display device obtains required power and relevant control signals.

Generally, most connectors of the display device are designed for commonly used and feasible for various data or signals transmitting. However, the output settings of the system circuit board may vary depending on the needs of display panel suppliers and subsequent processing manufacturers, therefore, in the assembly process of the system board there may be a mismatch between the system circuit board and the printed circuit board. Incorrect matching and signal transmitting may result in improper operation of the printed circuit board or damage to the display device.

### SUMMARY OF THE INVENTION

In order to solve the above-mentioned problems, it is an object of the present invention to provide a display apparatus implied a security module.

The purpose of the present invention and the aforementioned technical problem to be solved can be realized by the following technical embodiments.

According to the present invention, it provides a display apparatus, the display apparatus comprises a control module configured to provide a power supply signal and a plurality of control signals and configured to determine the operation of the control module in a first operation mode or a second operation mode according to a matching signal provided by the system circuit board transmitted to the printed circuit board. And, a security module is electrically coupled to the control module and configured to receive and transmit the power supply signal, wherein the security module including a plurality of switches comprises a first switch having a control terminal configured to receive a first control signal and a first terminal electrically coupled to the control module, a second switch having a control terminal configured to receive a second control signal and a first terminal electrically coupled to a second terminal of the first switch, a third switch having a control terminal configured to receive a third control signal and a first terminal electrically coupled to a second terminal of the second switch, a fourth switch having a control terminal configured to receive a fourth control signal and a first terminal electrically coupled to a second terminal of the third switch. Moreover, a displaying module is electrically coupled to a second terminal of the fourth switch, wherein an open state or a conducted state of each of the first switch, the second switch, the third switch and the fourth switch is controlled by the control module according to the operation mode of the control module. Also, the plurality of control signals of the control module transmitting to the displaying module and the power supply signal of the control module providing to the displaying module are controlled in a state of enable or disable according to the operation mode of the control module.

In one embodiment of the present invention, each of the first control signal, the second control signal, third control signal and the fourth control signal includes two potential states of a first voltage level and a second voltage level provided by the control module.

In one embodiment of the present invention, while in the first operation mode, the control module outputs the first voltage level to the first control signal and the second control signal, and the second voltage level to the third control signal and the fourth control signal.

In one embodiment of the present invention, wherein each of the first switch, the second switch, the third switch and the fourth switch is controlled in a conducted state, a plurality of control signals of the control module are transmitted to the displaying module, and the power supply signal of the control module provided to the displaying module is controlled in a state of enable.

In one embodiment of the present invention, while in the second operation mode, the control module outputs the second voltage level to at least one of the first control signal and the second control signal, or the first voltage level to at least one of the third control signal and the fourth control signal.

In one embodiment of the present invention, wherein at least one of the first switch, the second switch, the third switch and the fourth switch is controlled in the open state, and the power supply signal of the control module providing to the displaying module is controlled in a state of disable.

In one embodiment of the present invention, wherein the first voltage level is high voltage and the second voltage level is low voltage, or, the first voltage level is low voltage and the second voltage level is high voltage.

In one embodiment of the present invention, wherein the first voltage level provided to the first control signal and the second control signal is 3.3 volt, and the second voltage level provided to the first control signal and the second control signal is 0 volt.

In one embodiment of the present invention, wherein the first voltage level provided to the third control signal and the fourth control signal is 0 volt, and the second voltage level provided to the third control signal and the fourth control signal is 3.3 volt.

In one embodiment of the present invention, wherein each of the first switch and the second switch is a P-channel field effect transistor, and each of the third switch and the fourth switch is a N-channel field effect transistor.

In one embodiment of the present invention, wherein each of the first switch and the second switch is a N-channel field effect transistor, and each of the third switch and the fourth switch is a P-channel field effect transistor.

In one embodiment of the present invention, wherein the control module is disposed on the system circuit board.

In one embodiment of the present invention, wherein the security module is disposed on the printed circuit board.

The purpose of the present invention and the aforementioned technical problem to be solved can be further realized by the following technical embodiments.

Another object of the present invention is to provide a display apparatus, the display apparatus comprises a control module configured to provide a power supply signal and a plurality of control signals and configured to determine the operation of the control module in a first operation mode or a second operation mode according to a matching signal provided by the system circuit board transmitting to the printed circuit board. And, a security module is electrically coupled to the control module and configured to receive and transmit the power supply signal, wherein the security module including a plurality of switches comprises a first switch having a control terminal configured to receive a first control signal and a first terminal electrically coupled to the control module, a second switch having a control terminal configured to receive a second control signal and a first terminal electrically coupled to a second terminal of the first switch, a third switch having a control terminal configured to receive a third control signal and a first terminal electrically coupled to a second terminal of the second switch, a fourth switch having a control terminal configured to receive a fourth control signal and a first terminal electrically coupled to a second terminal of the third switch. Moreover, a displaying module having a display driving circuit and a second terminal of the fourth switch is electrically coupled to the display driving circuit, wherein each of the first control signal, the second control signal, third control signal and the fourth control signal includes two potential states of a first voltage level and a second voltage level provided by the control module.

Wherein the potential state of each of the first control signal, the second control signal, third control signal and the fourth control signal is adjusted according to the operation of the control module in the first operation mode or the second operation mode, an open state or a conducted state of each of the first switch, the second switch, the third switch and the fourth switch is consequently controlled, the plurality of control signals of the control module transmitted to the displaying module is controlled and the power supply signal of the control module provided to the displaying module is controlled in a state of enable or disable respectively. Wherein the control module is disposed on the system circuit board and the security module is disposed on the printed circuit board.

While the operation of the control module is determined in the first operation mode, the control module outputs the first voltage level to the first control signal and the second control signal and the second voltage level to the third control signal and the fourth control signal. Each of the first switch, the second switch, the third switch and the fourth switch is consequently controlled in the conducted state, the plurality of control signals of the control module are transmitted to the displaying module and the power supply signal of the control module provided to the displaying module is controlled in the state of enable.

While the operation of the control module is determined in the second operation mode, the control module outputs the second voltage level to at least one of the first control signal and the second control signal and the first voltage level to at least one of the third control signal and the fourth control signal. Meanwhile, at least one of the first switch, the second switch, the third switch and the fourth switch is consequently controlled in the open state, and the power supply signal of the control module provided to the displaying module is controlled in the state of disable.

The present invention by virtue of adding a security module disposed on a display apparatus and configured to disconnect the connection between the system circuit board and the printed circuit board when the system circuit board and the printed circuit board are not matched properly. So that the printed circuit board of the display apparatus is protected.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 is a schematic diagram of an exemplary display apparatus;

FIG. 2 is a block diagram of an exemplary display apparatus according to one embodiment of the present invention;

FIG. 3 is a schematic diagram of a security module according to one embodiment of the present invention;

FIG. 4a is a schematic diagram of another security module according to one embodiment of the present invention;

FIG. 4b is a schematic diagram of another security module according to one embodiment of the present invention; and

FIG. 4c is a schematic diagram of further another security module according to one embodiment of the present invention.

### DETAILED DESCRIPTION OF THE EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

Furthermore, in the specification, “on” implies being positioned above or below a target element and does not imply being necessarily positioned on the top on the basis of a gravity direction.

For further explaining the technical means and efficacy of the present invention, a display panel, a display apparatus and its applications including the embodiments, structures, features and effects thereof according to the present invention will be apparent from the following detailed description and accompanying drawings.

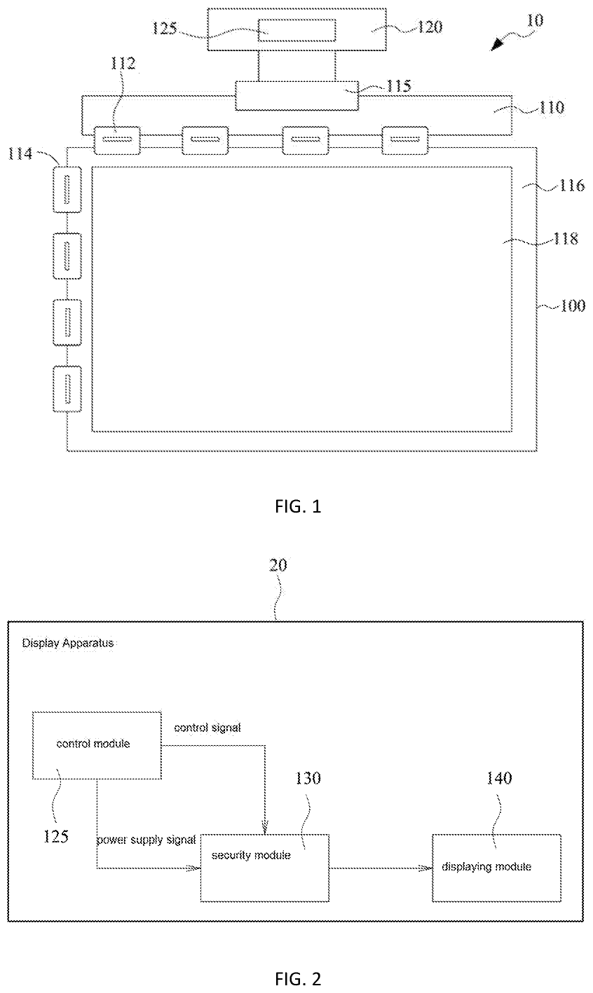

FIG. 1 is a schematic diagram of a display apparatus. Referring to FIG. 1, a display apparatus 10 comprises a system circuit board 120 having a control module 125, a printed circuit board (PCB) 110 having a timing controller (not shown in the figure) and a connector 125 connected to the system circuit board 120. Moreover, a display panel 100 includes a displaying region 118 and a fan out region 116, a plurality of source driving chips 112 and a plurality of gate driving chips 114 are disposed on the fan out region of different side of the display panel 100 respectively. Wherein, a plurality of signals such as the Red/Green/Blue compressing signals and the control signal provided by the system circuit board 120 are transmitted to the timing controller through the connector 115, and further processed by the timing controller then transmitted to the display panel 100 through the plurality of source driving chips 112 and the plurality of gate driving chips 114 respectively. However, the compatibility or the matching problems may be occurred between different system circuit board 120 and different printed circuit board 110. Once the compatibility or matching problem is occurred between the system circuit board and the printed circuit board, the inaccurate signals are transmitted and the improper operation in the printed circuit board 110 is occurred. Thereby, the displaying performance of the display panel been affected even the damage of the printed circuit board 110 may be occurred and the function of the display panel are limited consequently.

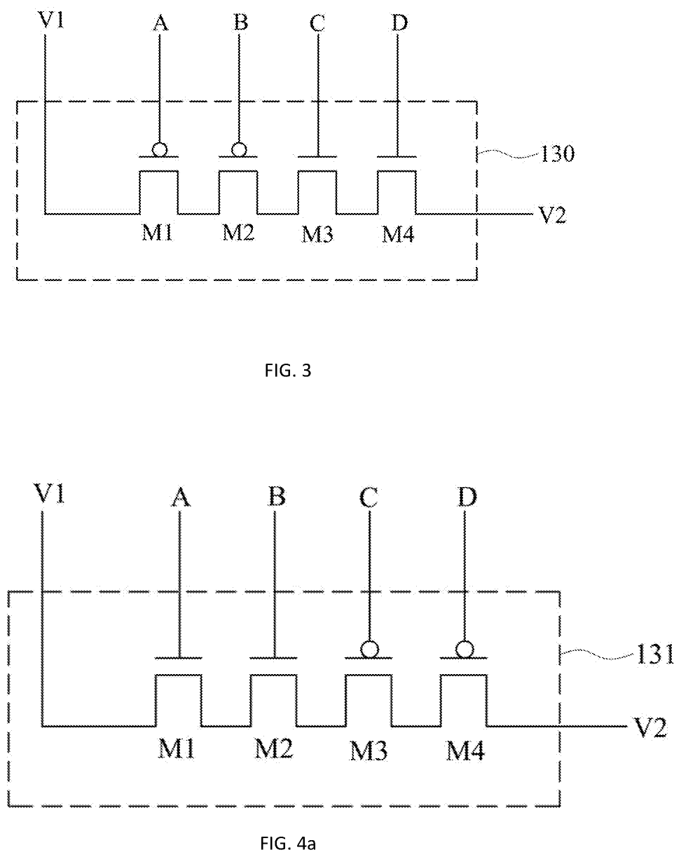

FIG. 2 is a block diagram of a display apparatus according to one embodiment of the present invention, and FIG. 3 is a schematic diagram of a security module according to one embodiment of the present invention. Referring to FIG. 2 and FIG. 3, in one embodiment of the present invention, a display apparatus 20 comprises a control module 125 configured to provide a power supply signal V1 and a plurality of control signals (A, B, C, and D) to determine the operation of the control module 125 in a first operation mode or a second operation mode according to a matching signal provided by the system circuit board transmitted to the printed circuit board. And, a security module 130 is electrically coupled to the control module 125 and is configured to receive and transmit the power supply signal V1, wherein the security module 130 includes a plurality of switches (M1, M2, M3, and M4) comprising a first switch M1 having a control terminal configured to receive a first control signal A and a first terminal electrically coupled to the control module 125, a second switch M2 having a control terminal configured to receive a second control signal B and a first terminal electrically coupled to a second terminal of the first switch, a third switch M3 having a control terminal configured to receive a third control signal C and a first terminal electrically coupled to a second terminal of the second switch, a fourth switch M4 having a control terminal configured to receive a fourth control signal D and a first terminal electrically coupled to a second terminal of the third switch. Moreover, a displaying module 140 is electrically coupled to a second terminal of the fourth switch M4, wherein the displaying module 140 shows the images to the viewer. Wherein an open state or a conducted state of each of the first switch M1, the second switch M2, the third switch M3 and the fourth switch M4 is controlled by the control module 124 according to the operation mode of the control module 125. Also, the plurality of control signals of the control module 125 transmitted to the displaying module 140 and the power supply signal V1 of the control module 125 provided to the displaying module 140 are controlled in a state of enable or disable respectively.

In one embodiment of the present invention, each of the first control signal A, the second control signal B, third control signal C and the fourth control signal D includes two potential states of a first voltage level and a second voltage level provided by the control module 125.

In one embodiment of the present invention, the connection between the first terminal and the second terminal of the plurality of switches (M1, M2, M3, and M4) is in series.

In one embodiment of the present invention, while the system circuit board on the display apparatus 20 is compatible with or successfully matched with the printed circuit board, the control module and the driving system of the display apparatus 20 can work normally, and then the control module 125 enters the first operation mode. In the first operation mode, the control module outputs the first voltage level, for example 3.3 volt, to the first control signal A and the second control signal B, and the second voltage level, for example 3.3 volt, to the third control signal C and the fourth control signal D.

In one embodiment of the present invention, wherein the first voltage level is logic low, and the second voltage level is logic high.

In one embodiment of the present invention, wherein each of the first switch and the second switch is a P-channel field effect transistor, and each of the third switch and the fourth switch is a N-channel field effect transistor. Due to the different types of the plurality of switches (M1, M2, M3, and M4), the voltages of the logic high level and the logic low level of the corresponding first voltage level and the second voltage level are also different. In the present embodiment, the first voltage level and the second voltage level provided to the first switch M1 and the second switch M2 are, for example, 3.3 volt and 0 volt respectively, and the first voltage level and the second voltage level provided to the third switch M3 and the fourth switch M4 are, for example, 0 volt and 3.3 volt respectively.

In one embodiment of the present invention, wherein each of the first switch M1, the second switch M2, the third switch M3 and the fourth switch M4 is controlled in a conducted state, a plurality of control signals of the control module 125 are transmitted to the displaying module 140, and the power supply signal (V1-V2) of the control module 125 provided to the displaying module through the plurality of switches (M1, M2, M3 and M4) is controlled in a state of enable.

In one embodiment of the present invention, while the system circuit board on the display apparatus 20 is not compatible with or unsuccessfully matched with the printed circuit board, the control module and the driving system of the display apparatus 20 can't work normally, and then the control module 125 enters the second operation mode. In the second operation mode, the control module outputs the second voltage level, for example 0 volt, to at least one of the first control signal A and the second control signal B, or the first voltage level, for example 0 volt, to at least one of the third control signal C and the fourth control signal D.

In one embodiment of the present invention, wherein the control module is outputted any voltage level to at least one of the plurality of control signals (A, B, C, and D), that is, at least one of the first switch M1, the second switch M2, the third switch M3 and the fourth switch M4 is controlled in an open state, thereby, the power supply signal V1 of the control module provided to the displaying module 140 is controlled in a state of disable. The power supply signal V1 cannot be transmitted to the displaying module 140 through the transmission of the plurality of switches (M1, M2, M3, and M4), so as to ensure the printed circuit board is not damaged due to the circuitry faults.

In one embodiment of the present invention, wherein the control module is disposed on the system circuit board, the security module is disposed on the printed circuit board, in other words, the security module 130 can be disposed on a connector of a printed circuit board, for example. Moreover, the displaying module having a display driving circuit and a plurality of pixel switches, the display driving circuit may further include source driving chip (Source-Chip on Film, S-COF), the gate driving chip (Gate-Chip on Film. G-COF), or the GOA circuit module (Gate Driver On Array, GOA), for example.

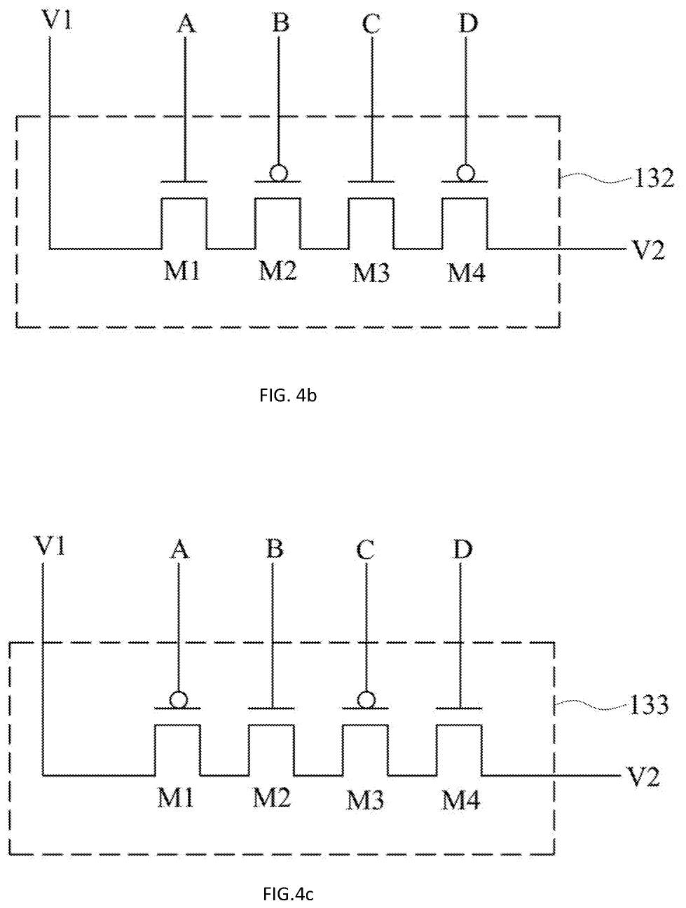

FIG. 4a is a schematic diagram of another security module according to one embodiment of the present invention. Referring to FIG. 4a, the security module 131 compared with the security module 130 of the previous embodiment, each of a first switch M1 and a second switch M2 is a N-channel field effect transistor, and each of a third switch M3 and a fourth switch M4 is a P-channel field effect transistor. Meanwhile, while the control module outputs a logic low level to the first control signal A and the second control signal B and a logic high level to the third control signal C and the fourth control signal D, a plurality of control signals of the control module 125 are transmitted to the displaying module 140, and the power supply signal (V1-V2) of the control module 125 provided to the displaying module is controlled in a state of enable. Furthermore, when the control module outputs any logic level to at least one of the plurality of control signals (A, B, C, and D), the signal transmitting between the control module 125 and the displaying module 140 is in a state of disable.

FIG. 4b is a schematic diagram of another security module according to one embodiment of the present invention. FIG. 4c is a schematic diagram of further another security module according to one embodiment of the present invention. Referring to FIG. 4b, the security module 132 comprises a first switch M1 and a second switch M2 each made of a N-channel field effect transistor, and a third switch M3 and a fourth switch M4 each made of a P-channel field effect transistor. Referring to FIG. 4c, the security module 133 comprises a first switch M1 and a second switch M2 each made of a P-channel field effect transistor, and a third switch M3 and a fourth switch M4 each made of a N-channel field effect transistor. Wherein by means of the switching of the potential state of each of the plurality of control signals (A, B, C, and D) is controlled, an open state or a conducted state of each of the plurality of switches (M1, M2, M3 and M4) is consequently controlled, and the power supply signal V1 of the control module provided to the displaying module 140 is controlled in a state of enable or disable respectively. In this way, the protection of the printed circuit board of the display apparatus 20 is realized, the product optimization rate is improved, and the production cost is reduced.

In some embodiments, the present invention by virtue of an open state or a conducted state of each of a plurality of switches is controlled by a plurality of control signals (A, B, C, and D), because of the plurality of switches are connected in series, therefore the control module 125 and the displaying module 140 are disconnected as long as any one of the switches is in open state. Only if the plurality of switches are opened simultaneously, the connection between the control module 125 and the displaying module 140 is conducted. Therefore, according to the design provided by the present invention, the faulty allowance of the display apparatus 20 can be greatly improved. In an embodiment of the present invention, the plurality of switches are illustrated as including four switches, but not limited thereto. The plurality of switches may also be a number including two switches, three switches or five switches.

The present invention by virtue of adding a security module (130, 130,132, or 133) disposed on a display apparatus 20 and configured to disconnect the connection between the system circuit board and the printed circuit board when the system circuit board and the printed circuit board are not matched properly. So that the printed circuit board of the display apparatus is protected.

In addition, in the specification, unless explicitly described to the contrary, the word “comprise” and variations such as “comprises” or “comprising” will be understood to imply the inclusion of stated elements but not the exclusion of any other elements.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A display apparatus, comprising:
a control module, configured to provide a power supply signal and a plurality of control signals, determining operation of the control module in a first operation mode or a second operation mode according to a matching signal provided by the system circuit board transmitted to the printed circuit board;
a security module, electrically coupled to the control module and configured to receive and transmit the power supply signal, wherein the security module including a plurality of switches comprises:
a first switch, having a control terminal configured to receive a first control signal and a first terminal electrically coupled to the control module;
a second switch, having a control terminal configured to receive a second control signal and a first terminal electrically coupled to a second terminal of the first switch;
a third switch, having a control terminal configured to receive a third control signal and a first terminal electrically coupled to a second terminal of the second switch; and
a fourth switch, having a control terminal configured to receive a fourth control signal and a first terminal electrically coupled to a second terminal of the third switch; and
a displaying module, electrically coupled to a second terminal of the fourth switch;
wherein an open state or a conducted state of each of the first switch, the second switch, the third switch and the fourth switch is controlled by the determination of the operation of the control module in the first operation mode or the second operation mode.

2. The display apparatus according to claim 1, wherein each of the first control signal, the second control signal, third control signal and the fourth control signal comprises two potential states of a first voltage level and a second voltage level provided by the control module.

3. The display apparatus according to claim 2, wherein while the operation of the control module is determined in the first operation mode, the control module outputs the first voltage level to the first control signal and the second control signal, and the second voltage level to the third control signal and the fourth control signal.

4. The display apparatus according to claim 3, wherein each of the first switch, the second switch, the third switch and the fourth switch is controlled in the conducted state, the plurality of control signals of the control module are transmitted to the displaying module.

5. The display apparatus according to claim 4, wherein the power supply signal of the control module provided to the displaying module is controlled in a state of enable.

6. The display apparatus according to claim 2, wherein while the operation of the control module is determined in the second operation mode, the control module outputs the second voltage level to at least one of the first control signal and the second control signal.

7. The display apparatus according to claim 6, wherein at least one of the first switch, the second switch, the third switch and the fourth switch is controlled in the open state, and the power supply signal of the control module provided to the displaying module is controlled in a state of disable.

8. The display apparatus according to claim 2, wherein while the operation of the control module is determined in the second operation mode, the control module outputs the first voltage level to at least one of the third control signal and the fourth control signal.

9. The display apparatus according to claim 8, wherein at least one of the third switch and the fourth switch is controlled in the open state, and the power supply signal of the control module provided to the displaying module is controlled in a state of disable.

10. The display apparatus according to claim 2, wherein the first voltage level is high voltage and the second voltage level is low voltage.

11. The display apparatus according to claim 2, wherein the first voltage level is low voltage and the second voltage level is high voltage.

12. The display apparatus according to claim 2, wherein the first voltage level provided to the first control signal and the second control signal is 3.3 volt, and the second voltage level provided to the first control signal and the second control signal is 0 volt.

13. The display apparatus according to claim 10, wherein the first voltage level provided to the third control signal and the fourth control signal is 0 volt, and the second voltage level provided to the third control signal and the fourth control signal is 3.3 volt.

14. The display apparatus according to claim 1, wherein each of the first switch and the second switch is a P-channel field effect transistor.

15. The display apparatus according to claim 14, wherein each of the third switch and the fourth switch is a N-channel field effect transistor.

16. The display apparatus according to claim 1, wherein each of the first switch and the second switch is a N-channel field effect transistor.

17. The display apparatus according to claim 16, wherein each of the third switch and the fourth switch is a P-channel field effect transistor.

18. The display apparatus according to claim 1, wherein the control module is disposed on the system circuit board.

19. The display apparatus according to claim 1, wherein the security module is disposed on the printed circuit board.

20. A display apparatus, comprising:
a control module, configured to provide a power supply signal and a plurality of control signals, determining operation of the control module in a first operation mode or a second operation mode according to a matching signal provided by the system circuit board transmitted to the printed circuit board;
a security module, electrically coupled to the control module and configured to receive and transmit the power supply signal, wherein the security module including a plurality of switches comprises:
a first switch, having a control terminal configured to receive a first control signal and a first terminal electrically coupled to the control module;
a second switch, having a control terminal configured to receive a second control signal and a first terminal electrically coupled to a second terminal of the first switch;
a third switch, having a control terminal configured to receive a third control signal and a first terminal electrically coupled to a second terminal of the second switch; and
a fourth switch, having a control terminal configured to receive a fourth control signal and a first terminal electrically coupled to a second terminal of the third switch; and
a displaying module having a display driving circuit, and a second terminal of the fourth switch electrically coupled to the display driving circuit;
wherein each of the first control signal, the second control signal, third control signal and the fourth control signal includes two potential states of a first voltage level and a second voltage level provided by the control module;
wherein the potential state of each of the first control signal, the second control signal, third control signal and the fourth control signal is adjusted according to the operation of the control module in the first operation mode or the second operation mode, an open state or a conducted state of each of the first switch, the second switch, the third switch and the fourth switch is consequently controlled, the plurality of control signals of the control module transmitted to the displaying module is controlled and the power supply signal of the control module provided to the displaying module is controlled in a state of enable or disable respectively;
wherein the control module is disposed on the system circuit board and the security module is disposed on the printed circuit board;
while the operation of the control module is determined in the first operation mode, the control module outputs the first voltage level to the first control signal and the second control signal and the second voltage level to the third control signal and the fourth control signal, each of the first switch, the second switch, the third switch and the fourth switch is consequently controlled in the conducted state, the plurality of control signals of the control module are transmitted to the displaying module and the power supply signal of the control module provided to the displaying module is controlled in the state of enable; and
while the operation of the control module is determined in the second operation mode, the control module outputs the second voltage level to at least one of the first control signal and the second control signal and the first voltage level to at least one of the third control signal and the fourth control signal, at least one of the first switch, the second switch, the third switch and the fourth switch is consequently controlled in the open state, and the power supply signal of the control module provided to the displaying module is controlled in the state of disable.
